(19) United States
(12) Patent Application Publication
(10) Pub. No.: US 2011/0311881 A1
(43) Pub. Date: Dec. 22, 2011

(54) LITHIUM SULFONATE POLYAZOLE SOLID POLYMER ELECTROLYTES IN POLYMER ELECTROLYTE LITHIUM ION BATTERIES AND SUPERCAPACITORS, AND PROCESSES OF FABRICATION

(76) Inventor: Brian C. BENICEWICZ, Columbia, SC (US)

(21) Appl. No.: 13/165,062

(22) Filed: Jun. 21, 2011

Related U.S. Application Data
(60) Provisional application No. 61/356,979, filed on Jun. 21, 2010.

(51) Int. Cl. H01M 10/0562; H01G 9/032; B29C 39/00; H01G 9/022; H01M 6/18; C08J 5/18

(52) U.S. Cl. 429/309; 429/310; 264/331.12; 252/62.2; 361/502

(57) ABSTRACT

The present invention relates to novel and improved solid polymer electrolytes (or ‘gel’ polymer electrolytes) membranes for use in polymer electrolyte battery assemblies, supercapacitors and other applications. The solid polymer electrolytes (SPE) are designed specifically for lithium ion batteries and are generally comprised of a polyazole ring-substituted lithium sulfonates (PARSLS). One or more non-aqueous, PARSLS compatible solvents may be incorporated, and one or more thermally stable ionic liquids, and one or more lithium salts may also be incorporated into the SPE membranes of this invention. The SPE membranes of this invention show uniquely high lithium ion transfer values, high current carrying capacity over a wide temperature range, excellent rechargeability, and good compatibility with anode and cathode materials. These SPE membranes also have very high thermal/chemical stability, are optically clear, and can be made completely nonflammable.

### FIELD OF THE INVENTION

The invention relates to solid polymer electrolytes (or gel polymer electrolytes) for use as separator-electrolyte membranes in primary and rechargeable lithium and lithium ion batteries.

### BACKGROUND OF THE INVENTION

In recent years, the demand for ever more effective batteries to serve ever more energy consuming electronic devices has increased dramatically. Of the battery chemistries in focus and to attempt to satisfy the growing necessity for battery performance, lithium and lithium ion cells by far show the most promise. Secondary (rechargeable) batteries based on lithium chemistry demonstrate high unit cell voltage and rechargeability combined with very high energy density, the latter quality offering advantages in battery size and weight. Lithium energy storage cells thus have found widespread use cellular phones and laptop computers as well as a myriad of other small portable electronic devices. It is now anticipated that after improvements in battery safety and other performance characteristics, lithium cells will be the selected energy storage means in the potentially enormous developing market for electric and hybrid vehicles. However, for the consumer automotive application, battery safety, batteries that are completely non-flammable, is absolutely essential.

As the current invention relates to improved lithium ion battery solid polymer electrolytes, it is useful to review the technical evolution of these electrolytes. Note, when solvents or plasticizers are added to a solid polymer electrolyte (SPE) they are sometimes referred to as a matrix or gel polymer electrolyte systems. This invention uses the term solid polymer electrolyte for the most part even when solvents or plasticizers are admixed with the usual components of a solid polymer electrolyte.

The general properties required of a suitable electrolyte system, and cells made therefrom, are well known and include primarily, 1) thermal and chemical stability, 2) compatibility/stability with both anode and cathode materials, 3) a broad voltage range (0-5V) and high output voltage and current, 6) high lithium ion conductivity over a temperature range of about −40° to 100° C. (>10⁻³S/cm), 7) a lithium ion transfer number approaching unity, 8) good current carrying capability, 9) electrochemical stability and low polarizability, 10) high charge cycle durability, and, 11) adequate membrane mechanical integrity. Also desired, but difficult to attain, would be a separator polymer electrolyte membrane with low electrical polarizability, that is, a membrane containing a lithium opposite-ion (anion) with limited mobility. A limited mobility anion prevents anion migration to the electrodes during battery charge and discharge, a phenomenon known to inhibit lithium migration as measured by a reduced ion transference number¹, and thus battery effectiveness.

To these must be added the commercially important characteristics of ease of manufacture and relatively low raw material cost. Finally, and through unfortunate experience, battery safety has risen as a necessary and perhaps premier quality, and therefore additional focus has been placed on electrolyte flammability. This quality is almost certain to be a prerequisite for widespread penetration of lithium batteries of the electric vehicle market.

Among the earliest electrolyte systems developed were combinations of microporous polymer separator membranes and liquid electrolytes comprised of aprotic solvents and lithium salts containing negative charge-diffuse anions. Such systems remain in widespread use today despite difficulties and expense of manufacture, solvent leakage and, of course, the risks of battery combustion. Typical aprotic and polar solvents are many and include organic carbonates, for example, ethylene carbonate, diethyl carbonate and propylene carbonate; certain lactones, such as gamma-butyrolactone; and, ethers such as diethoxyethane, tetrahydrofuran, and dioxolane. Acetonitrile, N-methylpyrrolidone and dimethylacetamide and dimethylformamide have also been used. Lithium salts in common use include LiBr, Lil, LiCl, LiNO₃ LiSCN, LiClO₄, LiPF₆, LiBF₄, LiAsF₆, LiB(Ph)₄, LiCH₃CO₂, LiC(CF₃SO₂)₂, LiSO₃CF₃, LiN(CF₃SO₂)₂, LiCF₃CO₂ and LiN(CF₃CO₂)₂.

A further advance of lithium ion battery electrolyte systems involved the development of solid polymer electrolytes²⁻³ (SPE), mixtures of polymers, frequently polyethylene oxide (PEO) and its derivatives and certain lithium salts. These materials generally do not have mechanical properties high enough to compensate for the much lower lithium ion conductivities (˜10⁻⁸ S/cm @ 20° C.) compared with those shown by solutions of lithium salts in organic solvents (>10⁻⁴ S/cm @ 20° C.). Further, under cooler operating conditions PEO is able to partially crystallize thus reducing lithium ion mobility. Note, a variant of a SPE is sometimes referred to as a polymer matrix electrolyte (PME). In lithium ion batteries, the SPE or PME serve as both separator between anode and cathode and lithium ion conductor between anode and cathode. The so-called polymer matrix electrolytes (PME) and variants of this approach, the gelled and sometimes cross-linked polymer electrolytes, were next, and seek to remedy weak film mechanical integrity and poor ion conductivity by the addition of solvents to plasticize or gel these newer polymer-based separator-electrolyte systems. Conductivities are improved in these systems showing in the range of 10⁻⁶ up to ˜10⁻³ S/cm, but mechanical properties for the most part remain poor and batteries made using them remain potential fire hazards.

In the prior art, examples of PME systems abound but reports of safe and cost-effective systems are not available. U.S. Pat. Nos. 7,129,005 and 7,198,870 disclose an electrolyte separator system using polyimides as the matrix materials. These patents teach the importance of homogeneity as defined by high optical transparency of the mixtures comprising a polyimide polymer, one or more organic solvents and one or more lithium salts. It is shown that lithium ion conductivity improves with system clarity suggesting that increasing turbidity, indicating separator phase separation is detrimental for this quality. Lithium ion conductivities of greater than 3×10⁻³ are reported. However, while polyimides have excellent chemical and thermal stability, very few polyimide materials are able to confer nonflammability on the types of systems disclosed. U.S. Pat. No. 7,544,445 also discloses use of a polyimide polymer in a polymer electrolyte separator system useful, it is claimed, for fuel cells, secondary batteries and capacitors. Here an electrolytic coating/filler of a solution comprising a stable aromatic polymer, typically an aromatic polysulfone and an ionic liquid, liquid at room temperature and typically, N-ethylimidazolium trifluoromethanesulfonate is cast unto a microporous polyimide membrane. The molten salt is stably held within and on the microporous polyimide to yield a membrane of high ionic conductivity, good mechanical integrity and high heat resistance. While the described compositions offer improvement in flame resistance over much of the relevant prior art, the membranes claimed would not provide nonflammability as defined by Limited Oxygen Index (LOI) evaluation⁵. Further, the compositions described do not contain a lithium ion providing component and therefore use of this technology in a lithium ion battery appears to be precluded, although fuel call and capacitor utility are not.

International Patent Publication No. WO 2008/070059 A2 discloses a unique lithium ion battery structure that recognizes the importance of anode and cathode PME compatibility, and describes a bilayer PME configuration that tailors separate chemistry for the PME layer facing the anode and the PME layer facing the cathode. The bilayer electrolyte structure is reported to extend battery durability and improve performance. While almost any polymer, solvent and lithium salt compositions could be tried as application examples for the technology disclosed, bilayer systems that demonstrate nonflammability are not disclosed here.

U.S. Pat. No. 6,949,317 recognizes prominently the need for improved electrolyte system safety in lithium secondary cells and lithium ion secondary cells. The patent describes PME systems comprising electrolyte solutions of a one or more lithium salts in at least two carbonate solvents-plasticizers and/or oligomeric carbonate solvents-plasticizers, both halogenated (generally fluorinated) and un-halogenated, in combination with a polymer matrix. The preferred and claimed polymer matrices are complex mixtures of interpenetrating or semi-interpenetrating networks comprised of the reaction polymers of polyisocyanates with polyols, polyol polymers, certain unsaturated acryloyl alcohols and optional chain extenders. The polymer matrix electrolytes reported here have useful lithium battery properties and would likely show some degree of fire retardance, but complete fire safety is likely not found in the compositions described.

### SUMMARY OF THE INVENTION

It is therefore the primary object of the invention to provide a solid polymer electrolyte membrane possessing the qualities of flame retardance, uniquely high lithium ion transfer values, high lithium conductivity over a broad temperature range, high energy density and operating current as well as charge cycle durability, thermal and chemical stability, compatibility/stability with both anode and cathode materials, a broad voltage range and high output voltage and current, good current carrying capability and good membrane mechanical integrity.

A second object of this invention is to provide solid polymer electrolyte membranes that may be made in a process that allows for facile and efficient manufacture of that SPE membrane; and further, a SPE membrane that lends itself to rapid and efficient manufacture of lithium and lithium ion cells in which the membrane will be used as a separator-electrolyte.

We have found that by using as a separator-electrolyte for secondary lithium cells a solid polymer electrolyte composed primarily of a nonflammable matrix polymer derivatized with a lithium salt of an alkyl (or aryl) or fluorinated alkyl sulfonic acid and an electrolyte solution containing one or more organic solvents and, optionally, one or more ionic liquids in place of those solvents or in addition to these solvents, and, optionally, one or more electrolyte salts, it is possible to produce improved secondary lithium cells possessing very high lithium transfer values and safety through flame retardance without sacrifice of any of the high performance characteristics required of the secondary cell.

Accordingly, the invention provides lithium ion-conducting polymer electrolyte membranes based on polyazole ring-nitrogen substituted fluoro-alkyl lithium sulfonate matrix polymers which can, because of their flame retardance, high lithium ion transfer values, excellent chemical and thermal properties, and ability to support, entrain, compatibilize and contain other lithium ion conducting solvents, ionic liquids, salts and additives be used in a variety of processes and compositions to form solid polymer electrolyte membranes (SPE) useful in lithium ion batteries. Thus, the solid polymer electrolyte membranes of this invention comprise:
A) a polyazole ring-nitrogen substituted fluoro-alkyl lithium sulfonate matrix polymer
B) polyazole ring-nitrogen substituted alkyl or aryl lithium sulfonate matrix polymer
C) a polyazole matrix polymer;
D) one or more organic solvents capable of solubilizing selected lithium salts and compatible with certain polyazole polymers
E) one or more ionic liquids miscible with the organic solvents selected, capable of solubilizing selected lithium salts and compatible with certain polyazole polymers
F) one or more lithium salts soluble and homogeneous with mixtures comprising selections from A to E.

Elements selected only from category A may be present solely in the compositions of this invention. To element(s) from category A, elements of B to F may be added in such a manner that the final composition is fully homogeneous and transparent, and capable of forming a solid polymer electrolyte membrane useful as separator-membranes in high performance lithium and lithium ion batteries. To these compositions there may be admixed additional polymers and/or other additives, some compatible and some not compatible, to further enhance membrane mechanical integrity and membrane battery performance. Preferred compositions are those that are completely nonflammable, and posses a high lithium ion transfer value.

Elements selected only from category B may also be present solely in the compositions of this invention. To element(s) from category B, elements of C to F may be added in such a manner that the final composition is fully homogeneous and transparent, and capable of forming a solid polymer electrolyte membrane useful as separator-membranes in high performance lithium and lithium ion batteries. To these compositions there may be admixed additional polymers and/or other additives, some compatible and some not compatible, to further enhance membrane mechanical integrity and membrane battery performance. Preferred compositions are those that are completely nonflammable, and posses a high lithium ion transfer value.

Polyazoles such as polybenzimidazoles (®Celazole) have been known for a long time⁷. The thermal stability and nonflammability, qualities long known but not well recognized for polybenzimidazoles, were described by L. R. Belohlav in 1974⁴. It was noted that PBI retains more than 80% of its original mass at temperatures as high as 900° C. in helium atmosphere. Even in air PBI shows only a slow and gradual oxidative process beginning at about 500° C. and without inflammation of the polymer. A method which offers some degree of quantitative comparison of flammability of different materials is provided by determination of a material's Limited Oxygen Index. Allowing for simplification, the LOI procedure measures the minimum amount of oxygen concentration in a controlled atmosphere necessary to permit combustion of specified geometry of a material when ignited from the bottom of the sample. Below is a table showing LOI (sample bottom ignition) values of several common polymers compared with that of PBI. Clearly, PBI is the only polymer tested that can be considered genuinely nonflammable in air (air=21% O₂) with an LOI of 28.5%. Note, the next least flammable polymer shown in this table is the aromatic polyimide Kapton (DuPont) with an LOI of 18.5% O₂ suggesting that most polyimide materials of this type are flammable in air and would be not be optimum selections for use as matrix polymers in SPE membranes if one seeks maximum lithium ion battery safety. Further, a 1986 reference⁶ on polybenzimidazole reports the glass transition temperature (Tg) of PBI to be 435° C. PBI, according to this disclosure, is nonflammable, producing little smoke in the presence of a flame source and forms a tough carbonaceous char up to 80% of the original PBI sample weight.

| Polymer⁴ | LOI (% O₂ bottom ignition) |
|---|---|
| Polyoxymethylene | 12.2 |
| Polypropylene | 15.3 |
| Poly(ethylene terephthalate) | 15.5 |
| Nylon 6,6 | 15.5 |
| Nomex (DuPont aromatic polyamide) | 17.0 |
| Kapton (DuPont aromatic polyimide) | 18.5 |
| Polybenzimidazole (Celanese) | 28.5 |

The preparation of such polybenzimidazoles (PBI) is usually carried out by reacting 3,3″,4,4″-tetraminobiphenyl with isophthalic acid or diphenylisophthalic acid or their esters in the melt⁶. The prepolymer formed solidifies in the reactor and is subsequently comminuted mechanically. The pulverized prepolymer is subsequently fully polymerized in a solid-phase polymerization at temperatures of up to 400° C. to give the desired polybenzimidazoles. Higher molecular weight polybenzimidazoles can be made in solution using polyphosphoric acid (PPA) as the polymerization solvent. Thus, the monomers named above react in PPA to form a viscous solution from which PBI polymer may be isolated by dilution of the polymer solution with water, or other non-solvent for the PBI. So-called ‘AB-PBI’, that is, starting with, for example, the monomer, 3,4-diaminobenzoic acid, may be made in a similar manner. The AB-PBI type is one of the preferred polyazoles of the present invention. A reference review of synthetic methods for polybenzimidazole type polyazole polymers is listed by Bower and Rafalko in U.S. Pat. No. 4,599,388.

To produce polymer films, the PBI is, in a further step, dissolved in polar, aprotic solvents such as dimethylacetamide (DMAc) and a film is produced by classical methods. PBI films may also be made by casting the PBI/PPA solution⁵ and washing the resulting PBI/PPA film with water to remove the PPA and phosphoric acid, and then dried to form another version of PBI film.

It has now been discovered that very effective nonflammable, lithium ion-conducting membranes are made from ring-nitrogen substituted fluoro-alkyl lithium sulfonate polyazole matrix polymers (PANFALS). Membranes for use in lithium ion batteries can be made directly from PANFALS without addition of other moieties. One may incorporate moieties chosen from the material categories B through F listed above to form a broad variety of membrane forming compositions.

PANFALS membranes may be prepared as follows: A carefully dried polyazole polymer solution in an aprotic solvent is treated with lithium hydride to form the N-lithium salt of the chosen polyazole polymer according to the method described by Sansone in U.S. Pat. No. 4,814,399. The lithium hydride may be added in solution to avoid localized precipitation. Since the hydride reaction generates hydrogen gas, completion of the reaction is indicated when the hydrogen ceases bubbling from the solution. When the lithium hydride is carried out as disclosed, at least about 50 percent of the polyazole imidazole hydrogen sites are ionized to lithium salt and more preferably more than 70 percent.

After hydrogen evolution is complete, a fluorinated alkyl sultone is added to the polyazole lithium salt solution to form a solution of polyazole N-substituted fluoro-alkyl lithium sulfonate. This solution is then cast on a suitable substrate and the solvent evaporated to an extent to form a PANFALS membrane. A certain amount of solvent may be retained by the PANFALS membrane to a level that does not compromise the nonflammability property of the membrane. Higher levels of electrolyte solvent may remain in the membrane and while these higher levels of solvent compromise nonflammability, these membrane compositions are also excellent solid polymer electrolytes for lithium ion batteries.

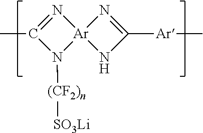

Sultones are cyclic compounds derived from hydroxyl alkyl sulfonic acids. Fluorinated sultones useful in the preparation of PANFALS polymers are selected from the sultone group represented by the cyclic formula —O—(CF₂)ₙ—SO₂—, where (n) may be 2-10. The preferred perfluorinated sultone is that where n=2, that is, 2-hydroxy-1,1,2,2-tetrafluoroethane sulfonic acid sultone (beta-perfluoro sultone). Non-fluorinated sultones may also be used alone or as mixtures with fluorinated sultones to form PANFALS membranes. When only non-fluorinated sultones are used, there are formed polyazole N-substituted alkyl lithium sulfonate polymers and useful solid polymer electrolyte membranes may be prepared from these variants as well.

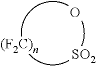

Although many types of sultones can be reacted with polyazole polymers useful as solid polymer electrolyte membranes for lithium ion batteries, the preferred sultones are beta (four member ring), gamma (five member ring), delta (six member ring) sultones and the most preferred are beta sultones. When beta sultones are employed as the sulfoalkylation agent, the sulfoalkylated polyazole polymers can be produced by a direct reaction between the polyazole polymer and the beta sultone. As described in U.S. Pat. No. 4,814,399, the reaction of gamma and delta sultones with a polyazole polymer is enhanced by first reacting the polyazole polymer with an alkali hydride, in this case lithium hydride, to form the polyazole polyanion. It may not be necessary to preform the polyazole anion with lithium hydride when using beta-perfluoro sultone.

A beta sultone having the following general formula may be utilized:

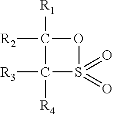

R1-4=H, F wherein R1-4 is hydrogen or fluorine to produce the N-substituted sulfopropyl derivative of the polyazole polymer chosen.

Steric strain in this 4-member ring sultone is such that it will react directly with the N—H group in the rings of the polyazole polymers without the need to first form the anion salt of the polyazole polymer. Thus, for example, in a variant of the process above to form a PANFALS with beta-perfluoro sultone, the beta-perfluoro sultone is first reacted with a dry solution of a polyazole polymer in an aprotic solvent to form a solution of N-1,1,2,2-tetrafluoroethane sulfonic acid polyazole polymer. This solution may be then treated with a stoichiometric quantity of lithium hydride to yield a solution N-1,1,2,2-tetrafluoroethane lithium sulfonate polyazole polymer, and this solution is then used to cast PANFALS membrane as described above.

Many variants of the compositions of the invention may be prepared by this general procedure. For example, the starting polyazole solution may contain a mixture several polyazole polymers, and mixtures of several solvents and/or ionic liquids, and one or more dissolved lithium salts. Suitable solvents include carbonate solvents such as methyl carbonate, dimethyl carbonate, butylene carbonate and diethyl carbonate. Other suitable solvents include N-methylpyrrolidone, lactones such as gamma-butyrolactone, dimethylsulfoxide, dimethylformamide, dimethylacetamide as well as nitrile solvents such as acetonitrile may also be used. Mixtures of two or more solvents are sometimes preferred. It is also a relatively simple matter to include additives and nano-additives in this solution to enhance SPE performance. Lithium salts dissolved in the starting polyazole polymer solution may include lithium hexafluorophosphate or lithium tetrafluoroborate (LiPF₆, LiBF₄) and mixtures thereof. Other useful lithium salts include those selected from the group which includes LiCl, LiBr, Lil, LiSCN, LiClO₄, LiBF₄, LiAsF₆, LiSO₃CF₃, LiSbF₆, LiPF₆, LiCF₃SO₂, LiAlO₄, LiNO₃, LiB(Ph)₄, LiCH₃CO₂, LiCF₃CO₂, LiAlCl₄, LiN(SO₂CF₃)₂, and mixtures thereof. In yet another embodiment of the invention, the PANFALS SPE after casting is taken to dryness, that is, the casting solvent is largely removed from the membrane. One or more ionic liquids above may be imbibed into the membrane to enhance both ion conductivity performance and to maintain complete nonflammability. The imbibed membrane is thus formed with an ionic liquid as the solvent in place of, or somewhat admixed with, the more traditional solvents mentioned here and in the prior art. Thus, an ionic liquid may also be used in place of a traditional solvent, ethylene carbonate for example. Examples of ionic liquids include 1-alkyl (or aryl)-3-methylimididazolium tetrafluoroborate, 1-alkyl (or aryl)-3-methylimididazolium hexafluorophosphate, 1-alkyl (or aryl)-3-methylimididazolium chlorate, etc. These ionic liquids may be used exclusively as the only liquid component in the PANFALS SPE membrane or in combination with solvents often employed in the fabrication of SPEs such as ethylene carbonate. Thus, a PANFALS SPE may be fabricated with one or more polyazole polymers, one or more ionic liquids and one or more lithium salts. It is preferred that the ionic liquid be added to the PANFALS SPE membrane after its formation.

In another embodiment of this invention, the PANFALS SPE membranes films may be doped with solutions of lithium salts and other additives in suitable organic solvents. The doping process involves immersing the PANFALS SPE membranes in said solution until the desired quantity of lithium salt solution or mixture has been absorbed by the membrane. The lithium salt solution may also be added to the PANFALS SPE membranes as a spray coat extensive enough to produce a doped membrane of desired composition. The resulting doped membrane can be used as a solid polymer electrolyte in lithium ion batteries.

The solutions of polyazole polymers may be formed by simply dissolving a polyazole polymer or mixture polyazole polymers in a suitable solvent or mixture of solvents. The solution of polyazole polymer(s) may also be prepared by polymerizing suitable monomers directly in the solvent(s) chosen. For example, monomers may be used to form a polyazole polymer such as the polybenzimidazole (PBI) from 3,3″,4,4″-tetraminobiphenyl and isophthalic acid. After monomer dissolution, the monomers are polymerized, with or without catalyst, to form a PBI polymer solution directly in an appropriate solvent. The solvent may also contain one or more lithium salts as described. In effect, the polyazole is prepared in situ using the lithium ion conducting solution as the polymerization medium. This polyazole polymerization may also be done in the absence of a lithium salt with said salt being added after polyazole polymerization is complete. After the lithium hydride and the preferred perfluoro-sulfoalkylation steps, PANFALS SPE membranes may be cast directly from these polymer solutions in a process involving some solvent evaporation to finalize PANFALS SPE formation. The resulting SPE may be used directly in the fabrication of lithium ion battery assemblies.

In yet another embodiment of the invention, after a PANFALS SPE has been prepared by any of the processes described above, all of the solvent (eg, ethylene carbonate) is driven off to form a ‘dry’ PANFALS SPE composed only of polyazole polymer and with or without added lithium salts, said salts in addition to that formed in lithium hydride/sultone procedures used to form the lithium sulfonate salt bound directly to the imidazole nitrogen of the polyazole polymer molecular chain. Small amounts of low volatility plasticizers such as dibutylphthalate or even propylene or ethylene carbonates may be allowed to remain in these versions of the PANFALS SPEs of this invention to improve lithium ion mobility and ease of battery fabrication.

In a variant of this approach to an improved PANFALS SPE for lithium ion batteries, that fraction of the imidazole nitrogen atoms in the polyazole polymers not perfluorosulfo alkylated before membrane casting may themselves be derivitized such that alkyl or aryl imidazolium polymer units are formed and interspersed along the polyazole chain. These imidazolium polyazole polymers may be incorporated into a PANFALS SPE in any of the embodiments described here. After imbibing with an ionic liquid such as a PBI-based PANFALS SPE membrane, the ionic liquid may be allowed to undergo ion exchange to form an imidazolium PBI-based PANFALS SPE polyazole polymer in situ. A nitrogen substituted alkyl or aryl imidazole is simply removed from the mixture to complete the polyazole derivitization process. The formation of imidazolium salts within the main chain of the polyazole polymer membrane can be employed to help foster phase homogeneity of the PANFALS SPE as well as improve SPE performance as a lithium cell separator-electrolyte membrane. This type of PANFALS SPE is particularly nonflammable in air, or when assembled in a lithium ion battery.

In a similar embodiment that fraction of the imidazole nitrogen atoms in the polyazole polymers not perfluorosulfo alkylated before membrane casting may also be derivitized by heating the membrane after imbibing with a carbonate solvent such as ethylene carbonate. Heating this imbibed membrane transforms the ethylene carbonate solvent to a reactant producing a hydroxyethylated polyazole polymer membrane. The hydroxethyl groups are affixed to the imidazole nitrogen atoms of the polyazole polymer. The formation of N-hydroxyethyl groups within the main chain of the polyazole polymer membrane can be employed to help foster phase homogeneity of the PANFALS SPE as well as improve SPE performance as a lithium cell separator-electrolyte membrane. A teaching of this long known reaction is given by Sansone et al in U.S. Pat. No. 4,826,502.

When this reaction is done in a carefully dried solution of a polyazole polymer, the hydroxyethyl groups may be further reacted with lithium hydride to form corresponding lithium alkoxide pendant groups which may be then reacted with a sultone, such as beta-perfluorosultone, to form imidazole nitrogen pendant ethyl ether-1,1,2,2-tetrafluoroethyl lithium sulfonate groups. The formation of N-partially fluorinated diethylether lithium sulfonate groups within the main chain of the polyazole polymer membrane can be employed to help foster phase homogeneity of the PANFALS SPE as well as improve SPE performance as a lithium cell separator-electrolyte membrane.

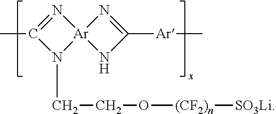

A representative graft variation is indicated by the following:

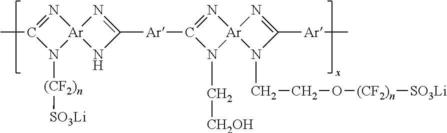

where in each instance Ar and Ar¹ are individually selected and are one or more aromatic ring.

Thus, several approaches may be employed in the practice of this invention to affix fluorinated-alkyl lithium sulfonate groups into polyazole polymers through reaction of the imidazole nitrogen atoms. To review possible polyazole derivatization processes and by example: (1) fluorinated-alkyl lithium sulfonate groups into polyazole polymers by partial or complete reaction of imidazole nitrogens with, for example, beta-perfluorosultone; (2) if partially reacted with beta-perfluorosultone, all or most of the remaining imidazole nitrogens may be hydroxethylated as described and further reacted with lithium hydride and beta-perfluorosultone to form ethyl ether-1,1,2,2-tetrafluoroethyl lithium sulfonate groups in addition to the perfluoroethyl lithium sulfonate groups formed in the previous reaction; and, (3) the polyazole polymer may be initially entirely or partially hydroxyethylated with, for example, ethyl carbonate and then in a second step treated with lithium hydride and, for example, beta-perfluorosultone to form in one case a polyazole polymer fully incorporating, for example, ethyl ether-1,1,2,2-tetrafluoroethyl lithium sulfonate groups; if the hydroxethylated is only partial, a subsequent exhaustive treatment with lithium hydride and beta-perfluorosultone will yield a polyazole polymer similar to that described in process (2) above. Each of the above described processes and permutations of these will lead to PANFALS SPE membranes useful as lithium cell separator-electrolyte membranes. Aromatic nitrogens when present in the polyazole polymers of this invention will tend to form pyridinium—sulfate anion ‘zwitterion’ groups along the main chains of the selected polyazole. These will be in addition to N-substituted fluoroalkyl lithium sulfonate groups. Although not necessary for the preparation of useful SPEs according to this invention, these zwitterions are expected to enhance to lithium ion mobility in SPE membranes containing such ionic groups.

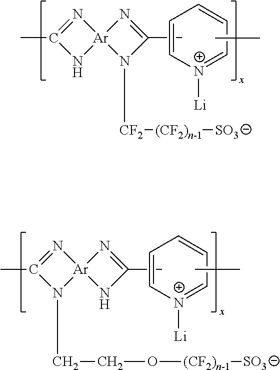

The present invention provides polymers to be used as matrix polymers in the preparation of a class of lithium ion conducting solid polymer electrolyte membranes. Within the material family of polyazoles, a typical class of which, the polybenzimidazoles, are preferred, and obtainable by a variety of synthetic routes including the process comprising the steps:

Mixing of one or more aromatic tetramino compounds with one or more aromatic carboxylic acids or esters thereof which contain at least two acid groups per carboxylic acid monomer, or mixing of one or more aromatic and/or heteroaromatic diaminocarboxylic acids, in polyphosphoric acid to form a solution and/or dispersion. This solution or dispersion is heated polymerization occurs, to form a viscous solution of the resulting polybenzimidazole in polyphosphoric acid. The polymer is isolated by diluting the solution with water or other polymer non-solvent to precipitate the polymer which is then easily separated. The polyazoles of this invention may also be prepared by solution polymerization, in a broad variety of suitable solvents, and by solid state polymerization. When using a solid state process, the phenyl esters of a selected diacid are often employed to facilitate polymerization.

The aromatic and heteroaromatic tetramino compounds used according to the invention are preferably 3,3′,4,4′-tetraaminobiphenyl, 2,3,5,6-tetraaminopyridine, 1,2,4,5-tetraaminobenzene, bis(3,4-diaminophenyl) sulfone, bis(3,4-diaminophenyl)ether, 3,3′,4,4′-tetraaminobenzophenone, 3,3′,4,4′-tetraaminodiphenylmethane and 3,3′,4,4′-tetraaminodiphenyldimethylmethane and also their salts, in particular their mono-, di-, tri- and tetrahydrochloride derivatives.

The aromatic carboxylic acids used according to the invention are dicarboxylic acids and tricarboxylic acids and tetracarboxylic acids or their esters or anhydrides or acid chlorides. The term aromatic carboxylic acids also encompasses heteroaromatic carboxylic acids. The aromatic dicarboxylic acids are preferably isophthalic acid, terephthalic acid, phthalic acid, 5-hydroxyisophthalic acid, 4-hydroxyisophthalic acid, 2-hydroxyterephthalic acid, 5-aminoisophthalic acid, 5-N,N-dimethylaminoisophthalic acid, 5-N,N-diethylaminoisophthalic acid, 2,5-dihydroxyterephthalic acid, 2,6-dihydroxyisophthalic acid, 4,6-dihydroxyisophthalic acid, 2,3-dihydroxyphthalic acid, 2,4-dihydroxyphthalic acid; 3,4-dihydroxyphthalic acid, 3-fluorophthalic acid, 5-fluoroisophthalic acid, 2-fluoroterephthalic acid, tetrafluorophthalic acid, tetrafluoroisophthalic acid, tetrafluoroterephthalic acid, 1,4-naphthalenedicarboxylic acid, 1,5-naphthalenedicarboxylic acid, 2,6-naphthalenedicarboxylic acid, 2,7-naphthalenedicarboxylic acid, diphenic acid, 1,8-dihydroxynaphthalene-3,6-dicarboxylic acid, bis(4-carboxyphenyl)ether, benzophenone-4,4′-dicarboxylic acid, bis(4-cargoxyphenyl) sulfone, biphenyl-4,4′-dicarboxylic acid, 4-trifluoromethylphthalic acid, 2,2-bis(4-carboxyphenyl)hexafluoropropane, 4,4′-stilbenedicarboxylic acid, 4-carboxycinnamic acid or their C1-C20-alkyl esters or C5-C12-aryl esters or their acid anhydrides or acid chlorides. The aromatic tricarboxylic or tetracarboxylic acids and their C1-C20-alkyl esters or C5-C12-aryl esters or their acid anhydrides or acid chlorides are preferably 1,3,5-benzenetricarboxylic acid (trimesic acid), 1,2,4-benzenetricarboxylic acid (trimellitic acid), (2-carboxyphenyl)iminodiacetic acid, 3,5,3′-biphenyltricarboxylic acid, 3,5,4′-biphenyltricarboxylic acid.

The aromatic tetracarboxylic acids or their C1-C20-alkyl esters or C5-C12-aryl esters or their acid anhydrides or acid chlorides are preferably 3,5,3′,5′-biphenyltetracarboxylic acid, 1,2,4,5-benzenetetracarboxylic acid, benzophenonetetracarboxylic acid, 3,3′,4,4′-biphenyltetracarboxylic acid, 2,2′,3,3′-biphenyltetracarboxylic acid, 1,2,5,6-naphthalenetetracarboxylic acid, 1,4,5,8-naphthalenetetracarboxylic acid.

The heteroaromatic carboxylic acids used according to the invention are heteroaromatic dicarboxylic acids and tricarboxylic acids and tetracarboxylic acids or esters or anhydrides thereof. For the purposes of the present invention, heteroaromatic carboxylic acids are aromatic systems in which at least one nitrogen, oxygen, sulfur or phosphorus atom is present in the aromatic. Preference is given to pyridine-2,5-dicarboxylic acid, pyridine-3,5-dicarboxylic acid, pyridine-2,6-dicarboxylic acid, pyridine-2,4-dicarboxylic acid, 4-phenyl-2,5-pyridinedicarboxylic acid, 3,5-pyrazoledicarboxylic acid, 2,6-pyrimidinedicarboxylic acid, 2,5-pyrazinedicarboxylic acid, 2,4,6-pyridinetricarboxylic acid, benzimidazole-5,6-dicarboxylic acid, and also their C1-C20-alkyl esters or C5-C12-aryl esters or their acid anhydrides or acid chlorides.

The content of tricarboxylic acids or tetracarboxylic acids (based on dicarboxylic acid used) is from 0 to 30 mol %, preferably from 0.1 to 20 mol %, in particular from 0.5 to 10 mol %.

The aromatic and heteroaromatic diaminocarboxylic acids used according to the invention are preferably diaminobenzoic acid and its monohydrochloride and dihydrochloride derivatives.

In step A), preference is given to using mixtures of at least 2 different aromatic carboxylic acids. Particular preference is given to using mixtures comprising aromatic carboxylic acids together with heteroatomic carboxylic acids. The mixing ratio of aromatic carboxylic acids to heteroaromatic carboxylic acids is in the range from 1:99 to 99:1, preferably from 1:50 to 50:1.

In particular, these mixtures are mixtures of N-heteroaromatic dicarboxylic acids and aromatic dicarboxylic acids. Nonlimiting examples are isophthalic acid, terephthalic acid, phthalic acid, 2,5-dihydroxyterephthalic acid, 2,6-dihydroxyisophthalic acid, 4,6-dihydroxyisophthalic acid, 2,3-dihydroxyphthalic acid, 2,4-dihydroxyphthalic acid, 3,4-dihydroxyphthalic acid, 1,4-naphthalenedicarboxylic acid, 1,5-naphthalenedicarboxylic acid, 2,6-naphthalenedicarboxylic acid, 2,7-naphthalenedicarboxylic acid, diphenic acid, 1,8-dihydroxynaphthalene-3,6-dicarboxylic acid, bis(4-carboxyphenyl)ether, benzophenone-4,4′-dicarboxylic acid, bis(4-carboxyphenyl) sulfone, biphenyl-4,4′-dicarboxylic acid, 4-trifluoromethylphthalic acid, pyridine-2,5-dicarboxylic acid, pyridine-3,5-dicarboxylic acid, pyridine-2,6-dicarboxylic acid, pyridine-2,4-dicarboxylic acid, 4-phenyl-2,5-pyridinedicarboxylic acid, 3,5-pyrazoledicarboxylic acid, 2,6-pyrimidinedicarboxylic acid, 2,5-pyrazinedicarboxylic acid.

The polyazole-based polymer formed comprises recurring azole units of the formula (I) and/or (II) and/or (III) and/or (IV) and/or (V) and/or (VI) and/or (VII) and/or (VIII) and/or (IX) and/or (X) and/or (XI) and/or (XII) and/or (XIII) and/or (XIV) and/or (XV) and/or (XVI) and/or (XVI) and/or (XVII) and/or (XVIII) and/or (XIX) and/or (XX) and/or (XXI) and/or (XXII):

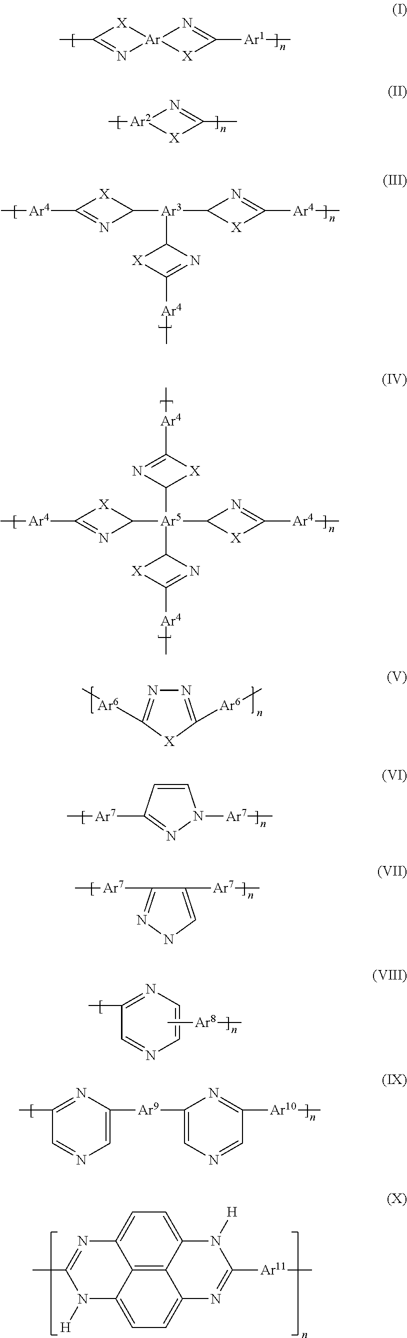

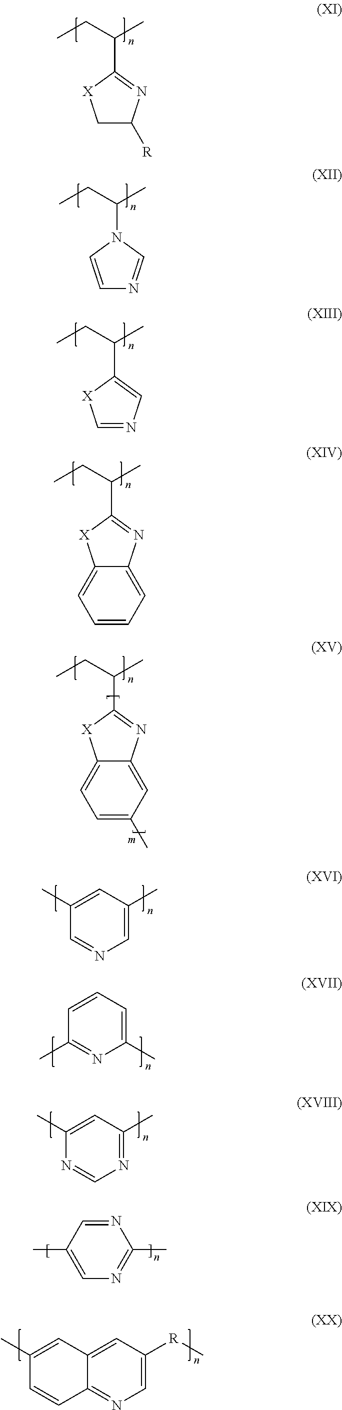

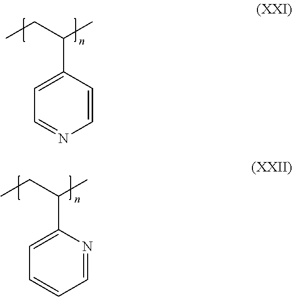

where

Ar are identical or different and are each a tetravalent aromatic or heteroaromatic group which may have one or more rings,

Ar1 are identical or different and are each a divalent aromatic or heteroaromatic group which may have one or more rings,

Ar2 are identical or different and are each a divalent or trivalent aromatic or heteroaromatic group which may have one or more rings,

Ar3 are identical or different and are each a trivalent aromatic or heteroaromatic group which may have one or more rings,

Ar4 are identical or different and are each a trivalent aromatic or heteroaromatic group which may have one or more rings,

Ar5 are identical or different and are each a tetravalent aromatic or heteroaromatic group which may have one or more rings,

Ar6 are identical or different and are each a divalent aromatic or heteroaromatic group which may have one or more rings,

Ar7 are identical or different and are each a divalent aromatic or heteroaromatic group which may have one or more rings,

Ar8 are identical or different and are each a trivalent aromatic or heteroaromatic group which may have one or more rings,

Ar9 are identical or different and are each a divalent or trivalent or tetravalent aromatic or heteroaromatic group which may have one or more rings,

Ar10 are identical or different and are each a divalent or trivalent aromatic or heteroaromatic group which may have one or more rings,

Ar11 are identical or different and are each a divalent aromatic or heteroaromatic group which may have one or more rings,

X are identical or different and are each oxygen, sulfur or an amino group bearing a hydrogen atom, a group having 1-20 carbon atoms, preferably a branched or unbranched alkyl or alkoxy group, or an aryl group as further radical,

R are identical or different and are each hydrogen, an alkyl group or an aromatic group and

n, m are each an integer greater than or equal to 10, preferably greater than or equal to 100.

Preferred aromatic or heteroaromatic groups are derived from benzene, naphthalene, biphenyl, diphenyl ether, diphenylmethane, diphenyldimethylmethane, bisphenone, diphenyl sulfone, quinoline, pyridine, bipyridine, pyridazine, pyrimidine, pyrazine, triazine, tetrazine, pyrrole, pyrazole, anthracene, benzopyrrole, benzotriazole, benzooxathiadiazole, benzooxadiazole, benzopyridine, benzopyrazine, benzopyrazidine, benzopyrimidine, benzopyrazine, benzotriazine, indolizine, quinolizine, pyridopyridine, imidazopyrimidine, pyrazinopyrimidine, carbazole, aciridine, phenazine, benzoquinoline, phenoxazine, phenothiazine, acridizine, benzopteridine, phenanthroline and phenanthrene, which may also be substituted.

Ar1, Ar4, Ar6, Ar7, Ar8, Ar9, Ar10, Ar11 can have any substitution pattern; in the case of phenylene for example, Ar1, Ar4, Ar6, Ar7, Ar8, Ar9, Ar10, Ar11 can each be ortho-, meta- or para-phenylene. Particularly preferred groups are derived from benzene and biphenyls, which may also be substituted.

Preferred alkyl groups are short-chain alkyl groups having from 1 to 4 carbon atoms, e.g. methyl, ethyl, n-propyl or i-propyl and t-butyl groups.

Preferred aromatic groups are phenyl or naphthyl groups. The alkyl groups and the aromatic groups may be substituted.

Preferred substituents are halogen atoms such as fluorine, amino groups, hydroxy groups or short-chain alkyl groups such as methyl or ethyl groups.

Preference is given to polyazoles comprising recurring units of the formula (I) in which the radicals X are identical within a recurring unit.

The polyazoles can in principle also comprise different recurring units which differ, for example, in their radical X. However, they preferably have only identical radicals X in a recurring unit.

Further, preferred polyazole polymers, in addition to the polybenzimidazoles, are polyimidazoles, polybenzothiazoles, polybenzoxazoles, polyoxadiazoles, polyquinoxalines, polythiadiazoles, poly(pyridines), poly(pyrimidines), and poly(tetrazapyrenes).

In a further embodiment of the present invention, the polymer comprising recurring azole units is a copolymer or a blend comprising at least two units of the formulae (I) to (XXII) which differ from one another. The polymers can be present as block copolymers (diblock, triblock), random copolymers, periodic copolymers and/or alternating polymers.

In a particularly preferred embodiment of the present invention, the polymer comprising recurring azole units is a polyazole which contains only units of the formula (I) and/or (II).

The number of recurring azole units in the polymer is preferably greater than or equal to 10. Particularly preferred polymers have at least 100 recurring azole units.

For the purposes of the present invention, polymers comprising recurring benzimidazole units are preferred. Some examples of the extremely advantageous polymers comprising recurring benzimidazole units have the following formulae:

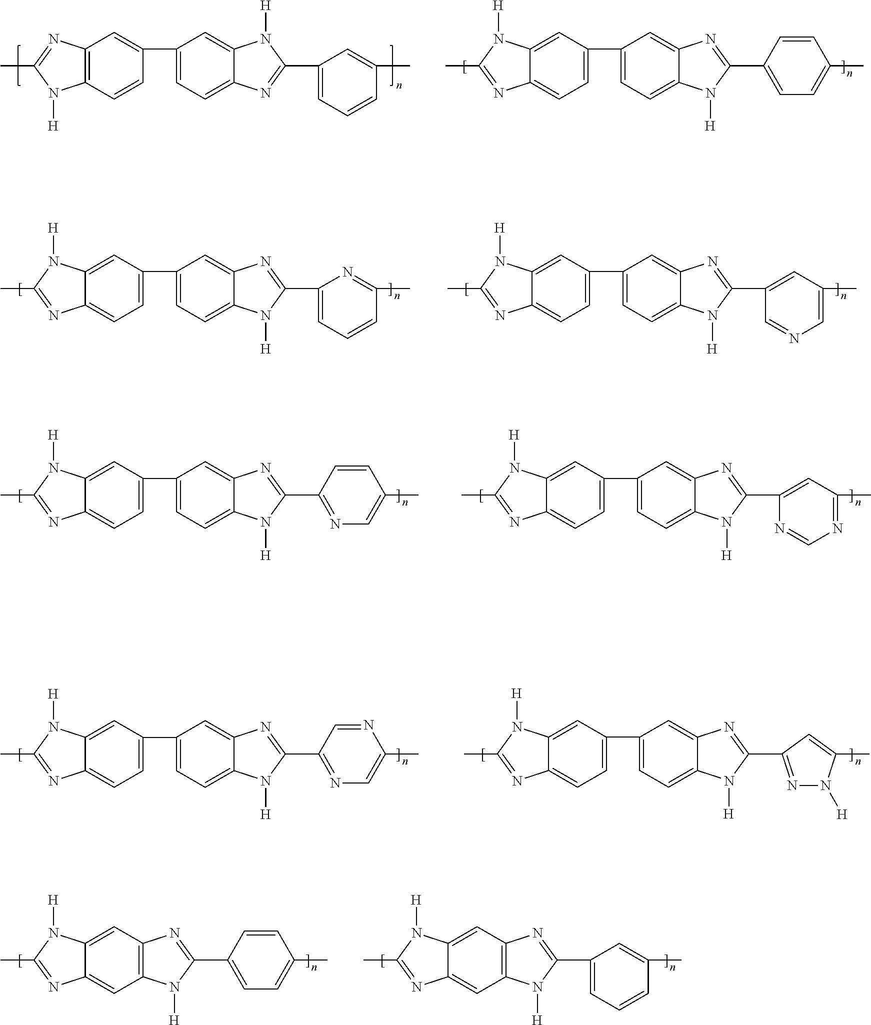

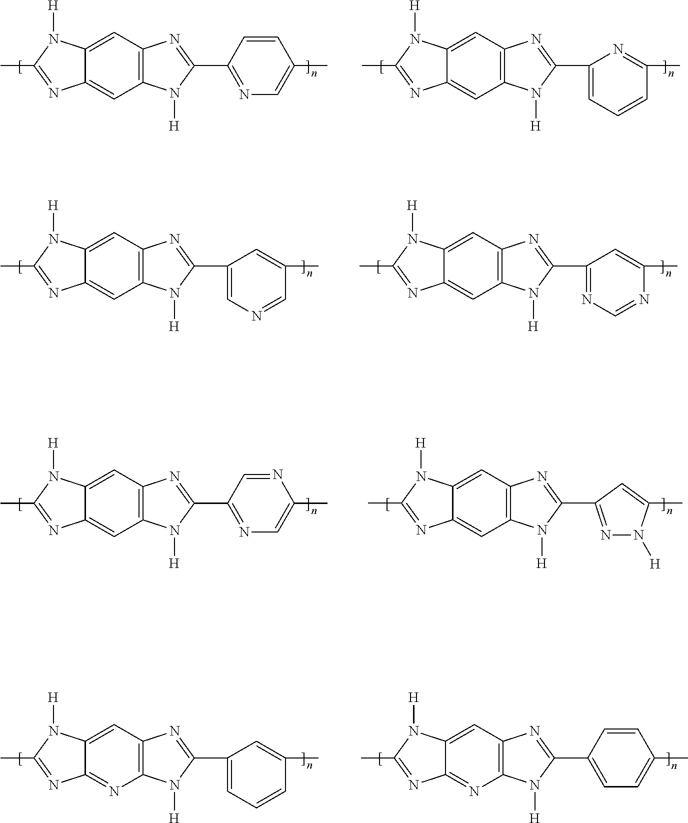

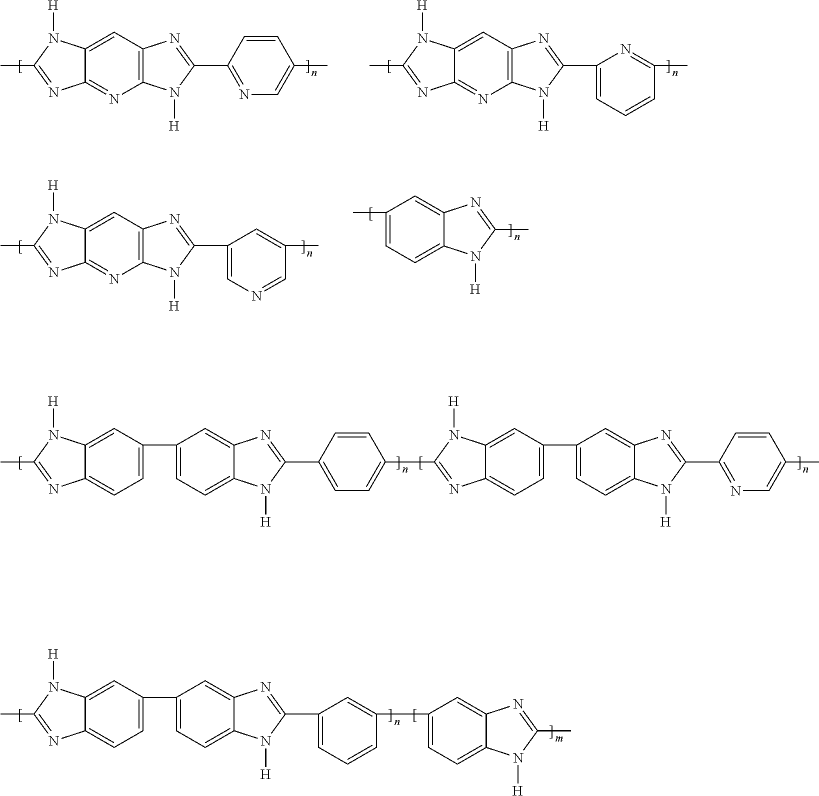

where n and m are each an integer greater than or equal to 10, preferably greater than or equal to 100.

The polyazoles obtainable by means of the process described, in particular the polybenzimidazoles, have a high molecular weight. Measured as intrinsic viscosity, this is at least 1.4 dl/g and is thus significantly above that of commercial polybenzimidazole (IV<1.1 dl/g), although commercial polymer may also be used in this invention.

If desired, the mixture obtained may comprise tricarboxylic acids or tetracarboxylic acids and thus branching/crosslinking of the polymer formed may be achieved in this way. This contributes to an improvement in the mechanical properties of the SPE after the uncrosslinked SPE has been formulated and fabricated into a membrane. If thermally induced crosslinking is performed, solvent is removed after membrane casting and re-added after crosslinking has been accomplished to reconstitute the SPE membrane.

Thus, the membrane can be crosslinked on the surface by action of heat in the presence of atmospheric oxygen. This hardening of the membrane surface effects an additional improvement in the properties of the membrane.

Crosslinking can also be achieved by action of IR or NIR (IR=infrared, i.e. light having a wavelength of more than 700 nm; NIR=near IR, i.e. light having a wavelength in the range from about 700 to 2000 nm or an energy in the range from about 0.6 to 1.75 eV). A further method is irradiation with β-rays. The radiation dose is in this case in the range from 5 to 200 kGy.

To achieve a further improvement in the use properties, fillers, in particular fillers that would aid in lithium ion conductivity, may be added to the SPE membrane fabrication solution. The addition can be carried out either during or after the polymerization.

Nonlimiting examples of lithium ion-conducting nanoparticulate enhancing fillers for the SPE membranes of this invention are include but are not limited to: Al₂O₃, AlOOH, BaTiO₃, BN, LiN₃ LiAlO₂, lithium fluorohectorite, and/or fluoromica clay. A useful additive such as hexamethyldisilazane (HMDS) may also be introduced to improve interfacial resistance in a lithium cell and trap (react) with any available water and HF that be present and harmful to cell performance.

The possible fields of use of the solid polymer, or matrix polymer, electrolyte membranes according to the invention include, inter alia, use in batteries, in electrolysis, and in capacitors. Owing to their property profile, SPE membranes are preferably used in batteries, specifically, lithium and lithium ion batteries.

### General Measurement Methods:

The electrochemical stability window is measured by linear sweep voltametry of an inert electrode in the selected electrolyte.

Galvanostatic charge/discharge measurements are examined between 3.0 and 4.2 V using a WonA Tech Co. Battery Cycler 3000.

### Method of Measuring the Specific Conductivity:

Ionic conductivity is determined by ac impedance spectroscopy using a Zahner IM6 Impedance Analyzer. Specific test conditions were developed by Min-Kyu Song et al.⁸

### EXAMPLES

### Example 1

### Imbibing mPBI Films

A solid polymer electrolyte membrane (SPE) can be prepared by imbibing a commercially available meta-polybenzimidazole (mPBI) with the appropriate solvents and lithium salt combination. Depending on the solvent and salt combination used, the membrane can either take up the solution or dissolve. Approximately 50 mg of mPBI was placed in a vial with 10 ml 1.0 M lithium triflate (LiTr) in ethylene carbonate (EC), (made from 13.2 g EC and 1.56 g LiTr). The solutions were place in ovens at 80° C., 140° C., and 180° C. The membrane imbibed at the lower temperature exhibited a 14% weight gain within the first six hours, attaining a weight gain of 19.5% after 96 hours. The imbibed membrane was plasticized by the EC and appeared transparent orange. The film was stable at temperatures up to 120 C.

### Example 2

### Imbibing pPBI Films

Para-polybenzimidazole (pPBI) films were prepared by the polyphosphoric acid method that results in a membrane that contains approximately 57% by weight phosphoric acid and 37% by weight water. In order to produce a SPE that can used in a battery, the phosphoric acid must be washed from the membrane. To 2.16 g pPBI washed film, (0.25 g dry equivalent) is added to 1.0M LiTr in EC (made from 5.62 g LiTr dissolved in 47.56 g EC). This solution was heated to 110° C. for 48 hours. Under these conditions, the film maintains its shape and absorbs the LiTr electrolyte solution. The resulting membranes are transparent and orange.

Conductivity measurements were obtained using a Zahner conductivity test station at five temperatures from 25° C. to 85° C. The samples shown in the graph are all pPBI films imbibed with 1.0 M soltions of LiTr in ethylene carbonate, 1-ethyl-3-methylimidazolium triflate (EMIMTr) and ethylene carbonate/propylene carbonate (EC/PC) made in the manner as previously described.

In addition to the conductivity measurements on these samples, Diffusion Ordered Spectroscopy (DOSY) experiments were performed at room temperature on a Bruker Avance DRX-400 Nuclear Magnetic Resonance (NMR) spectrophotometer and are shown in Table 1. The mobility of the lithium cation can be directly measured by this technique and in the case of the triflate anion, the mobility can be measured by looking at the diffusivity of the fluorine atoms in the salt.

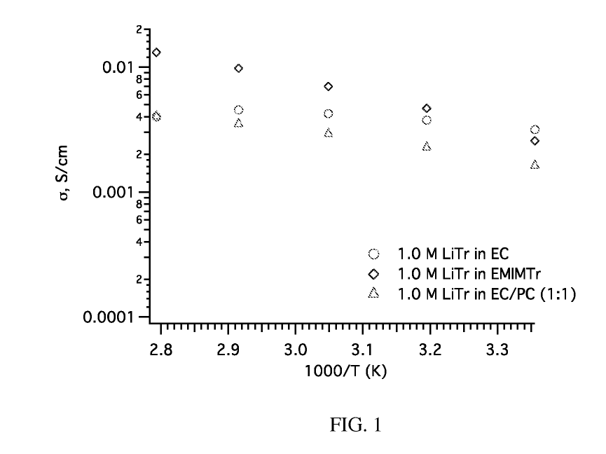

FIG. 1 presents conductivity values for three pPBI SPE membranes as a function of temperature.

TABLE 1
Diffusivity measurements at 296° C.

| | Li Diffusivity (m²/sec) | | F Diffusivity (m²/sec) |
|---|---|---|---|
| 1.0M LiTr in EC | 3.50 × 10⁻¹¹ | > | 3.33 × 10⁻¹¹ |
| 1.0M LiTr in | 8.67 × 10⁻¹² | << | 1.46 × 10⁻¹¹ |
| EMIM | | | |
| 1.0M LiTr in | 1.05 × 10⁻¹⁰ | < | 1.24 × 10⁻¹⁰ |
| EC/PC | | | |
| pPBI LiTr EC | 3.72 × 10⁻¹¹ | < | 4.47 × 10⁻¹¹ |
| pPBI LiTr EMIM | Below threshold | << | 1.45 × 10⁻¹¹ |
| pPBI LiTr EC/PC | 6.01 × 10⁻¹¹ | > | 5.14 × 10⁻¹¹ |

The values of the lithium diffusivity are similar to other known battery films made from polymers with lower flammability ratings such as those reported by Cheung et al. for lithium triflate in polyethylene oxide, 2.2×10⁻¹¹ m²/sec.⁹

### Example 3

### Casting Films From 1.0 M Li Salt Solutions

A SPE can also be prepared by casting a film from a solution of a 1.0 M lithium salt solution of mPBI in an aprotic polar solvent with a cosolvent that is commonly used in battery electrolyte solutions. 20 g mPBI, 12.48 g LiTr, and 67.46 g dry dimethylacetamide is weighed into a 250 ml stainless steel pressure vessel. The vessel is then purged with nitrogen before it is sealed. The bomb is heated to 220° C. with constant agitation for 16 hours then cooled to 60° C. for the addition of the γ-butyrolactone. The solution is then stirred for another 4 hours before a film is cast on a glass plate. The film is allowed to dry in a 60° C. oven for 24 hours. The resulting film is a transparent yellow/orange with a thickness of 25 μm.

As cast, the resulting film could be handled readily and did not appear or feel wet, but was determined to contain 5.5 weight percent water and 19.1 weight percent solvent by thermogravimetric analysis. After washing a sample of the film three times with 75° C. distilled water for two hours then drying it in a vacuum oven at 65° C. overnight, the film was found to contain 45.3 weight percent mPBI. The free volume or void space was then calculated by normalizing these values to that of a dry film. In this example the free space in the film that is occupied by the lithium salt was 39.9%. This pore value is similar to the pore volume found in commercial battery separator membranes made from polymers of lower flammability ratings.

Prior to the assembly of a button half cell, the membrane was further dried at 65° C. overnight to remove the residual water. The half cell was assembled using LiCoO for the cathode and LiC6 for the anode. 1.0 M LiPF6 in dimethyl carbonate/ethylene carbonate was used as the electrolyte. The output of the test cell was 3.5V.

While the preferred embodiments of the invention have been illustrated and described, it will be understood that the invention is not so limited. The preferred embodiments, for example, may be blended with other polymers preferably chosen from the class of polyazole polymers. Numerous other modifications, alterations, variants, changes, additions and substitutions and equivalents will occur to those with ordinary skill in the art without departing from the spirit and scope of the present invention as described in the claims.

### CITED REFERENCES

1) P. G. Bruce, F. Krok, and C. A. Vincent, Solid State Ionics, 27 (1988), p. 81. (PANFALS)
2) M. B. Armand, J. M. Chubagno, and M. Duclot in P. Vashita, J. M. Mundy, G. K. Sherroy (eds.), Fast Ion Transport in Solids, North Holland, Amsterdam, 1979; M. B. Armand, Solid State Ionics 9 & 10: 745-754 (1983).
3) Handbook of Batteries 3^{rd} ed., p 34.15, D. Linden, T. B. Reddy (eds.), McGraw-Hill, 2002.
4) L. R. Belohlav, Die Angewante Makromolekulare Chemie, 40/41 (1974), p. 465-483 (no. 581).
5) J. Mader, L. Xiao, T. Schmidt, B. C. Benicewicz, Polybenzimidazole/Acid Complexes as Temperature Membranes, Advances in Polymer Science, Ed. G. Sherer, Special Vol. Fuel Cells, Springer-Verlag, 2006.
6) E. J. Powers and G. A. Serad, High Performance Polymers: Their Origin and Development, R. B. Seymour and G. S. Kirshenbaum, eds. New York (1986), pp. 355-373.
7) H. A. Vogel and C. S. Marvel, J. Polym. Sc.i 50 (1961) p. 511; A. B. Conciatori and E. C. Chenevey, Macromol. Synth. 3 (1968) p. 24; A. B. Conciatori, E. C. Chenevey, T. C. Bohrer and A. E. Prince, J. Polym. Sci. Part C, 19 (1967) p. 49.
8) M.-K. Song, Y.-T. Kim, Y. T. Kim, B. W. Cho, B. N. Popov, H.-W. Rhee, J. Electrochem. Soc. 150 (2003), p. A439
9) I. W. Cheung, K. B. Chin, E. R. Greene, M. C. Smart, S. Abbrent, S. G. Greenbaum, G. K. S. Prakash, S. Surampudi, Electrochemica Acta, 48 (2003), p. 2149.

I claim:

1. A nonflammable solid polymer electrolyte or matrix (SPE or PME) composition comprising:
one or more ring-nitrogen substituted alkyl and/or fluoroalkyl lithium sulfonate polyazole polymer and/or hydroxyethylated polyazole polymer, and optionally at least one lithium salt, at least one solvent or ionic liquid, wherein said polyazole polymer, lithium salt and solvent and/or ionic liquid form a composition that is substantially homogeneous and optically clear, and can be made nonflammable.

2. The SPE of claim 1, wherein the matrix polymer(s) is prepared from a) the group of polybenzimidazoles (PBI), polybenzobisoxazoles (PBO), polybenzobisthiazoles (PBT), polyoxadiazoles, polyquinoxalines and polythiadiazoles, and b) a beta sultone having the following general formula: 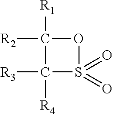
R1-4=H, F wherein R1-4 is hydrogen or fluorine to produce the N-substituted sulfopropyl derivative of the polyazole polymer chosen.

3. The SPE of claim 1, wherein the matrix polymer(s) is prepared from a) the group of polybenzimidazoles (PBI), polybenzobisoxazoles (PBO), polybenzobisthiazoles (PBT), polyoxadiazoles, polyquinoxalines and polythiadiazoles, wherein some fraction of ring nitrogens are hydroxyethylated, and b) a beta sultone having the following general formula: 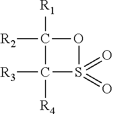
R1-4=H, F wherein R1-4 is hydrogen or fluorine to produce the N-substituted sulfopropyl derivative of the polyazole polymer chosen.

4. The SPE of claim 1, wherein the matrix polymer(s) is prepared from a polybenzimidazole (PBI).

5. The SPE of claim 1, wherein the matrix polymer(s) is PBI made from the polymerization or copolymerization of 3,4-diaminobenzoic, 3,3′,4,4′-tetraminobiphenyl with terephthalic acid and/or isophthalic acid, or derivatives of same.

6. The SPE of claim 1, wherein the matrix polymer(s) is PBI made from the polymerization or 3,4-diaminobenzoic acid or derivatives of same.

7. The SPE of claim 1, wherein the matrix polymer(s) is PBI made from the polymerization or copolymerization of 3,4-diaminobenzoic, 3,3′,4,4′-tetraminobiphenyl with terephthalic acid and/or isophthalic acid, or derivatives of same and 3,4-diaminobenzoic acid or derivatives of same.

8. The SPE of claim 2, wherein the beta sultone is 2-hydroxy-1,1,2,2-tetrafluoroethane sulfonic acid.

9. The SPE of claim 1, wherein the lithium salt is selected from the group consisting of LiCl, LiBr, Lil, LiSCN, LiClO₄, LiBF₄, LiAsF₆, LiSO₃CF₃, LiSbF₆, LiPF₆, LiCF₃SO₂, LiAlO₄, LiNO₃, LiB(Ph)₄, LiCH₃CO₂, LiCF₃CO₂, LiAlCl₄, LiN(SO₂CF₃)₂, and mixtures thereof.

10. The SPE of claim 1, wherein the solvent(s) is selected from the group consisting of ethylene carbonate, propylene carbonate, dimethyl carbonate, diethyl carbonate, 1,2-dimethyl ether, 1,2-diethyl ether, gamma-butyrolactone, acetonitrile, dimethyl formamide, dimethyl sulfoxide, and mixtures thereof.

11. The SPE of claim 1, wherein the ionic liquid(s) is selected from the group consisting of alkyl substituted imidazolium tetrafluoroborates, acetates, trifluoromethanesulfonates, nitrates, and mixtures thereof.

12. A process for preparing an SPE of claim 1 comprising the steps of:
a) preparing a solution of a polybenzimidazole polymer in one or more solvents selected from the group consisting of ethylene carbonate, propylene carbonate, dimethyl carbonate, diethyl carbonate, 1,2-dimethyl ether, 1,2-diethyl ether, gamma-butyrolactone, acetonitrile, dimethyl formamide, and dimethyl sulfoxide;
b) drying said solution;
c) mixing said dried solution with lithium hydride to produce a solution of a polybenzimidazole polyanion;
d) reacting the polybenzimidazole polyanion solution with a perfluorinated sultone;
e) optionally adding one or more lithium salts selected from LiCl, LiBr, Lil, LiSCN, LiClO₄, LiBF₄, LiAsF₆, LiSO₃CF₃, LiSbF₆, LiPF₆, LiCF₃SO₂, LiAlO₄, LiNO₃, LiB(Ph)₄, LiCH₃CO₂, LiCF₃CO₂, LiAlCl₄, LiN(SO₂CF₃)₂, and mixtures thereof to the polybenzimidazole polyanion solution of step d); and
f) casting the solution of step d) or e) onto a substrate with partial or complete evaporation of the solvent(s) to form a nonflammable solid polymer electrolyte membrane.

13. The process of claim 12, wherein said perfluorinated sultone of step d) is 2-hydroxy-1,1,2,2-tetrafluoroethane sulfonic acid.

14. A process for preparing an SPE of claim 1, comprising the steps of:
a) preparing a solution of a polybenzimidazole polymer in one or more solvent comprising ethylene carbonate, or a derivative of ethylene carbonate;
b) heating this solution to form a solution of partially or completely hydroxyethylated polybenzimidazole;
c) drying said solution to form a partially or completely hydroxyethylated polybenzimidazole solution;
d) mixing said partially or completely hydroxyethylated polybenzimidazole solution with lithium hydride to produce a solution of the corresponding polybenzimidazole polyanion or mixture of polybenzimidazole polyanions;
e) reacting the resulting hydroxyethylated polybenzimidazole polyanion solution with a perfluorinated sultone;
f) optionally adding one or more lithium salts selected from the group consisting of LiCl, LiBr, Lil, LiSCN, LiClO₄, LiBF₄, LiAsF₆, LiSO₃CF₃, LiSbF₆, LiPF₆, LiCF₃SO₂, LiAlO₄, LiNO₃, LiB(Ph)₄, LiCH₃CO₂, LiCF₃CO₂, LiAlCl₄, LiN(SO₂CF₃)₂, and mixtures thereof; and
g) casting the solution of step e) or f) onto a substrate with partial or complete evaporation of the solvent(s) to form a nonflammable solid polymer electrolyte membrane.

15. The process of claim 13, wherein said perfluorinated sultone of step e) is 2-hydroxy-1,1,2,2-tetrafluoroethane sulfonic acid.

16. A battery comprising a solid electrolyte, wherein the solid electrolyte comprises the nonflammable solid polymer electrolyte or matrix SPE or SME) polymer according to claim 1.

17. A battery comprising a solid electrolyte, wherein the solid electrolyte comprises the nonflammable solid polymer electrolyte or matrix SPE or SME) according to claim 2.

18. A supercapacitor comprising a solid electrolyte, wherein the solid electrolyte comprises the nonflammable solid polymer electrolyte or matrix SPE or SME) according to claim 1.

19. A supercapacitor comprising a solid electrolyte, wherein the solid electrolyte comprises the nonflammable solid polymer electrolyte or matrix SPE or SME) according to claim 2.
